(19) United States
(12) Patent Application Publication
(10) Pub. No.: US 2026/0226978 A1
(43) Pub. Date: Aug. 6, 2026

(54) Modular Shift Knob Assembly with Adjustable Weighting and Interchangeable Tops

(71) Applicant: Zachary Moylan Schary, Garland, TX (US)

(72) Inventor: Zachary Moylan Schary, Garland, TX (US)

(21) Appl. No.: 19/211,598

(22) Filed: May 19, 2025

Related U.S. Application Data
(60) Provisional application No. 63/754,101, filed on Feb. 5, 2025.

(51) Int. Cl. F16H 59/02

(52) U.S. Cl. CPC F16H 59/0278

(57) ABSTRACT

A modular shift knob assembly featuring a core body adapted for connection to a vehicle shift lever or other control shaft and one or more removable weight elements for adjusting mass distribution and tactile response. The assembly further includes interchangeable knob shells attachable to the core body, enabling variation of external geometry while maintaining compatibility with the weight system. The configuration allows tuning of knob weight, balance, and ergonomics to influence shift feel and driver control, and may also be adapted for other mechanical control levers.

### CROSS-REFERENCE TO RELATED APPLICATIONS

This application claims the benefit of U.S. Provisional Patent Application No. 63/754,101, filed on Feb. 5, 2025, which is incorporated herein by reference in its entirety.

### FIELD OF THE INVENTION

This invention relates to modular control knobs, and more particularly to gear shift knobs for vehicles featuring adjustable internal mass and interchangeable outer shells. It may also apply to mechanical control knobs for other applications such as industrial, gaming, or aviation controls.

### BACKGROUND

Conventional gear shift knobs used in automobiles are typically fixed in shape and weight, limiting the driver's ability to customize tactile feel and control response. While some aftermarket knobs offer style changes, few enable meaningful mass adjustment or modular interchangeability. Enthusiast drivers, racers, and aftermarket installers benefit from tactile tuning to optimize shift response, especially in performance applications. Although non-automotive uses are possible, the immediate need and commercial relevance is centered in the vehicle aftermarket shift knob space.

### SUMMARY OF THE INVENTION

The invention is a modular shift knob assembly comprising a core body adapted to attach to a gear shift lever or other control shaft, a threaded coupling interface, removable weight components, and multiple interchangeable knob shells. The assembly allows for tuning of mass distribution, shape, and weight balance to meet driver preference. Alternate knob shells may be quickly swapped onto the core body, and internal weights may be added or removed to adjust the tactile response and balance of the knob.

### BRIEF DESCRIPTION OF THE DRAWINGS

FIG. 1 is an exploded isometric view showing the modular components of the shift knob system.

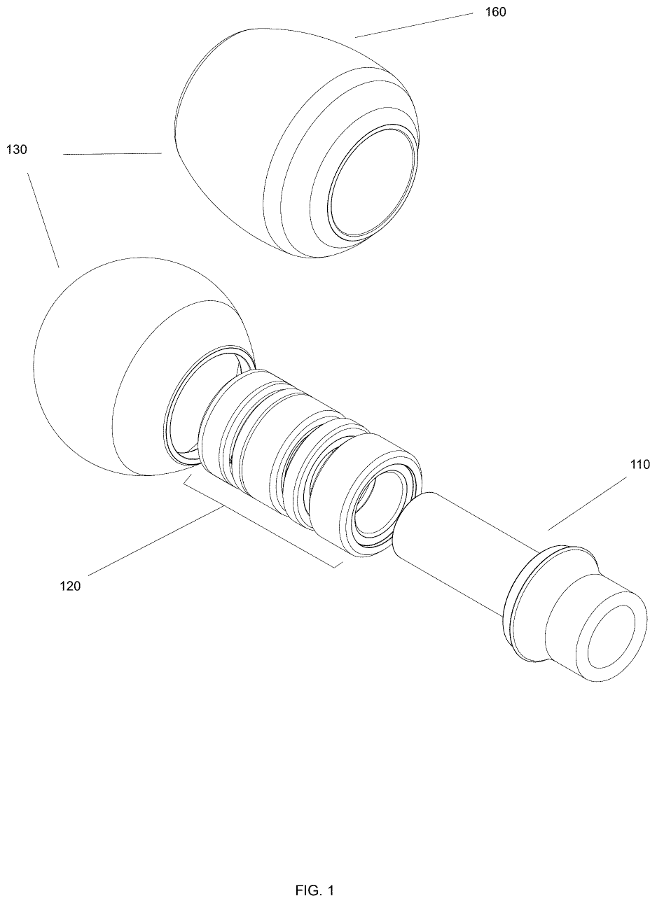

FIG. 2 is a cross-sectional view showing the internal structure and placement of weight components within the knob shell.

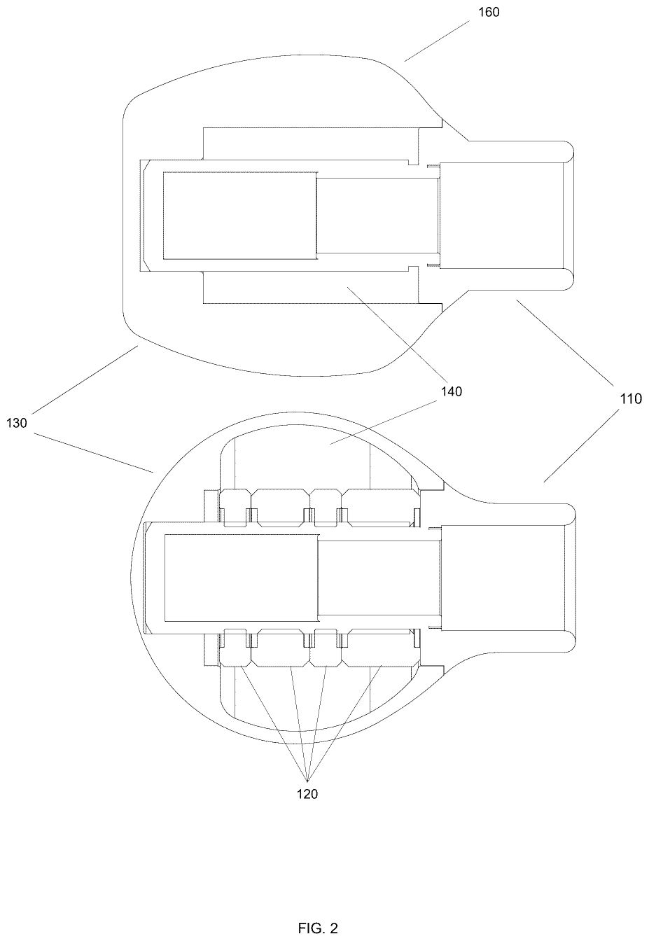

FIG. 3 is a side view of the assembly featuring an alternate knob top shape mounted to the core body.

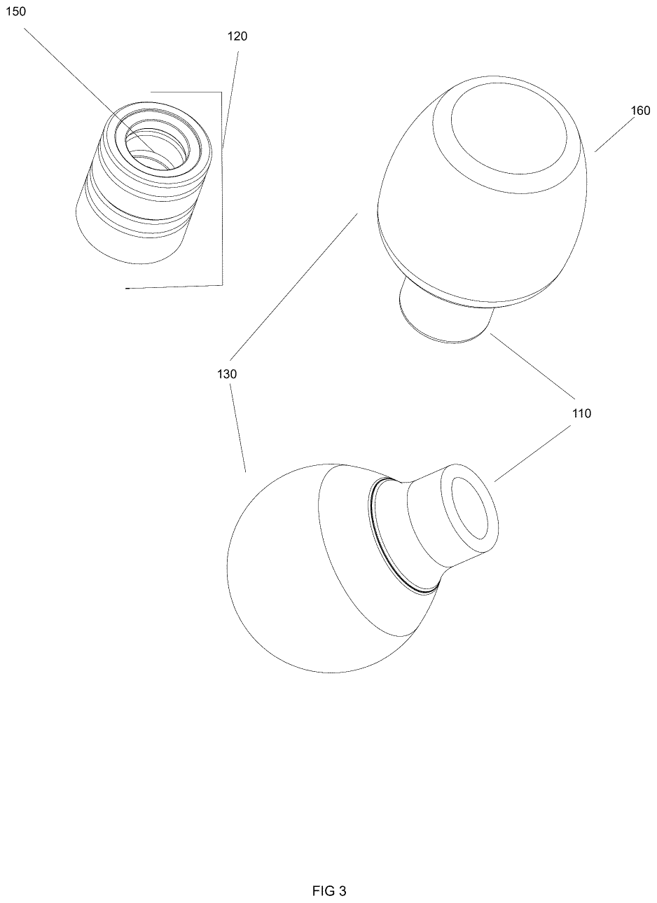

### DETAILED DESCRIPTION OF THE PREFERRED EMBODIMENT

Referring to the accompanying drawings:
110 refers to the core body, which interfaces with the vehicle's shift lever or control shaft and serves as the central structural element.
120 represents one or more removable weight elements designed to tune the total mass and balance of the assembly.
130 refers to the primary knob shell, which attaches to the core body and defines the ergonomic outer shape.
140 identifies the internal cavity or relief space within the knob shell to reduce weight or accommodate weights.
150 is the threaded coupling interface between the core body and the shell or weight.
160 refers to an alternate knob shell, interchangeable with the primary shell to offer different tactile or aesthetic options.

The system is designed such that the knob shell (130 or 160) threads onto the core body (110) via interface (150), securing the assembly. Optional weights (120) may be threaded onto or installed within the internal cavity (140) to increase knob mass for improved control feel and shifting precision. All components are modular and designed for repeated assembly/disassembly. The alternate knob shell (160) demonstrates compatibility with the same core body, enabling different ergonomic or stylistic preferences.

In alternate embodiments, one or more weight elements may be affixed directly to the gear shift lever or control shaft, separate from the knob assembly. These shaft-mounted weights can be clamped, threaded, or otherwise secured beneath or adjacent to the knob interface to adjust mass distribution, vibration damping, or tactile feedback. Such configurations are within the scope of the present invention, particularly where the weight system remains modular or tunable in nature.

The core innovation is the adjustability of mass-achieved by positioning removable weights on or within the assembly to directly influence the tactile shift experience. The mass may be centered or offset, heavier or lighter, depending on the installed weight set and chosen shell. The system may also incorporate alignment features (not numbered), such as a flat or mechanical stop, to allow for consistent rotational positioning between the knob shell and the core body.

While the primary application is for vehicle shift knobs, particularly in aftermarket performance and enthusiast installations, the concept may extend to other control levers requiring modular mass or ergonomic customization.

Materials may include aluminum, stainless steel, brass, or polymers.

End of Specification

1. A modular shift knob assembly comprising:
(a) a core body configured to be mounted onto a gear shift lever or other mechanical control shaft;
(b) one or more weight elements integrated into or removably attachable to the assembly for selectively adjusting the mass distribution of the shift knob;
(c) a knob shell configured to removably attach to the core body, wherein the knob shell encloses at least a portion of the weight elements; and
(d) a mechanical interface that allows for interchangeability of knob shells with different external geometries while maintaining consistent engagement and rotational alignment with the core body,
wherein the position of the weight elements is configured to influence tactile response, shift feel, and motion characteristics of the knob during operation.
The modular shift knob assembly of claim 1, wherein the weight elements are removable and attachable to either the core body or the knob shell and are enclosed within the assembly to allow for modular adjustment of total weight.
The modular shift knob assembly of claim 2, wherein the weight elements are positioned to adjust the center of gravity, modify the balance point relative to the control shaft axis, and influence tactile response and motion characteristics during operation.
The modular shift knob assembly of claim 1, wherein the knob shell is removable and attachable to the core body via a threaded or non-threaded mechanical interface configured to enable repeatable alignment and secure engagement, thereby allowing the user to change the external shape and tactile feel of the knob without modifying the internal components of the assembly.
The system of claim 1, further comprising one or more weight elements mountable directly to the shift lever or control shaft, independent of the knob assembly, to affect mass distribution and tactile response.
